(19) United States
(12) Patent Application Publication
(10) Pub. No.: US 2008/0169906 A1
(43) Pub. Date: Jul. 17, 2008

(54) Tooth-Attach Rfid Tag And System For Using The Same

(76) Inventors: Ji Hoon Joo, Seoul (KR); Jung Seo Park, Seoul (KR)

Correspondence Address: RATNERPRESTIA, P O BOX 980, VALLEY FORGE, PA, 19482-0980, US

(21) Appl. No.: 11/794,868

(22) PCT Filed: Jan. 10, 2006
(86) PCT No.: PCT/KR06/00095

§ 371 Date: Jan. 9, 2008

(30) Foreign Application Priority Data
Jan. 10, 2005 (KR) 10-2005-0002199

(51) Int. Cl. H04Q 5/22

(52) U.S. Cl. 340/10.1

(57) ABSTRACT

The present invention relates to RFID (radio frequency identification), more particularly to an RFID tag attached to a tooth and a system for using the same. The tooth-attached RFID tag of the present invention comprises a chip for storing the user's information, an antenna for transmitting the user information stored in the chip, a housing for fixing the chip and the antenna and a protective resin attached to a tooth for covering the housing, so that it may be protected from food or saliva. The semi-permanent tooth-attached RFID tag of the present invention offers an effective way of user identification.

### TECHNICAL FIELD

The present invention relates to RFID (radio frequency identification), more particularly to an RFID tag attached to a tooth and a system for using the same.

### BACKGROUND ART

A large number of children and adults are exposed to traffic accidents and other hazards. And, each year, thousands of people get lost or kidnapped.

In order to prepare for such dangerous situations, children and elders wear name tags, necklaces or bracelets on which their personal information or address are recorded.

However, if they forget to wear the name tag, necklace or bracelet, they cannot be protected enough from traffic accidents or other hazards.

RFID is an advanced technique capable of solving such a problem. The RFID technique removes the need of contacting, which is required in conventional bar codes or magnetic cards.

Korean Utility Model Application Nos. 2003-21682 and 2004-15723 disclose use of the RFID technique.

FIG. 1 illustrates an example of use of RFID tag, in which the RFID tag is attached at a portion where the upper and the sole of a specially-designed shoe contact each other.

However, the situation is no different from the conventional name tags, necklaces or bracelets, if the shoes are not worn. And, the shoes may be worn away or lost.

FIG. 2 illustrates another example of use of RFID tag, in which the RFID tag, which transmits a radio frequency signal of, e.g., 900 MHz, is built in a bracelet also having a built-in lock. The radio frequency signal transmitted from the RFID tag is decoded by an RFID reader and transmitted to the host computer, so that the latest traveling route, the patron's individual information, etc. can be managed in real time.

However, also similarly to the afore-mentioned shoes, the RFID bracelet cannot provide any protection from emergencies when it is not worn by the children or elders.

That is, conventional methods are limited in that the user has to wear the apparatus all the time. And, shoes or bracelets with RFID tags further have the possibility of causing allergic reactions depending on from what material they are made.

And, in case the shoes, bracelets, necklaces, etc. containing the wearer's identity information are removed intentionally, no proper measure can be taken.

### DISCLOSURE OF INVENTION

### Technical Problem

It is an object of the present invention to provide a semi-permanent RFID tag that is attached to a tooth for removing the inconvenience of wearing or carrying and a system and a method for using the same to quickly identify its user's information.

### Technical Solution

In order to attain the object, the present invention provides a tooth-attached RFID tag comprising a chip for storing the user's information, an antenna for transmitting the user information stored in the chip, a housing for fixing the chip and the antenna and a protective resin attached to a tooth for protecting the housing from food or saliva by covering the housing.

The present invention further provides a method for attaching an RFID tag comprising the steps of pre-treating the surface of a tooth by acid etching, coating an attach resin on an RFID tag and polymerizing the attach resin, so that it is attached on the surface of the pre-treated tooth, wherein the RFID tag comprises a chip for storing the user's information, an antenna for transmitting the user information stored in the chip, a housing for fixing the chip and the antenna and a protective resin attached to a tooth for protecting the housing from food or saliva by covering the housing.

The present invention further provides a system for using an RFID tag comprising an RFID tag which contains the user information and is attached to a tooth, a reader which reads and decodes the tooth-attached RFID tag, a network which provides the user information decoded by the reader to a server and a server which receives the user information from the network and compares it with the user information stored in the server.

The present invention further provides a method for using an RFID tag comprising the steps of pre-treating the surface of a tooth by acid etching, coating an attach resin on an RFID tag, polymerizing the attach resin, so that it is attached on the surface of the pre-treated tooth, reading the RFID tag through a reader as its user travels around, transmitting the user information decoded by the reader to a server via a network and comparing the transmitted user information with the user information compared in the server, wherein the RFID tag comprises a chip for storing the user information, an antenna for transmitting the user information stored in the chip, a housing for fixing the chip and the antenna and a protective resin attached to a tooth for protecting the housing from food or saliva by covering the housing.

### Advantageous Effects

The present invention offers the following advantages.

Since the RFID tag is attached to the user's tooth, the user information can be identified quickly in such emergencies as traffic accident or disappearance.

When the reader for the RFID tag is installed in a vehicle, approach of its user can be perceived and thus a car accident may be prevented. And, in an amusement park or a department store, missing or disappearance can be prevented by installing the reader in the gate or other facilities.

When such an apparatus as medical sensor is further equipped in the RFID tag, medical conditions inside the mouth can be diagnosed, too.

While the present invention has been described in detail with reference to the preferred embodiments, those skilled in the art will appreciate that various modifications and substitutions can be made thereto without departing from the spirit and scope of the present invention as set forth in the appended claims.

### BRIEF DESCRIPTION OF THE DRAWINGS

FIGS. 1 and 2 illustrate conventional use of RFID tags.

FIG. 3 shows the RFID tag of the present invention.

FIG. 4 is the cross-sectional view of FIG. 3.

FIG. 5 shows the arrangement of teeth to which the RFID tag of the present invention is to be attached.

FIG. 6 is the front view of the RFID tag of the present invention attached to a tooth.

FIG. 7 is the side view of FIG. 6.

FIG. 8 is a schematic diagram of the RFID tag-based individual positioning system in accordance with the present invention.

FIG. 9 is a flowchart for the individual positioning system of FIG. 8.

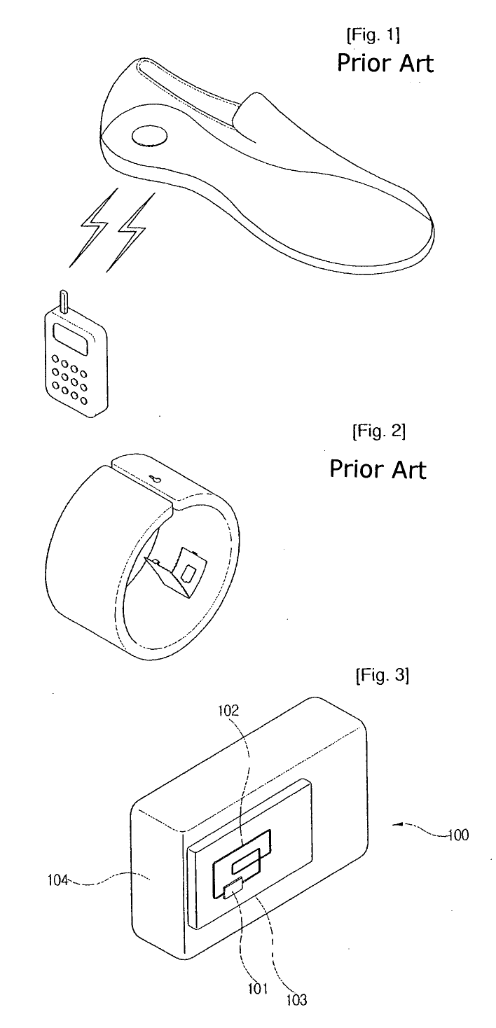

### BEST MODE FOR CARRYING OUT THE INVENTION

Hereinafter, the present invention is described in further detail with reference to the preferred embodiments, referring to the attached drawings.

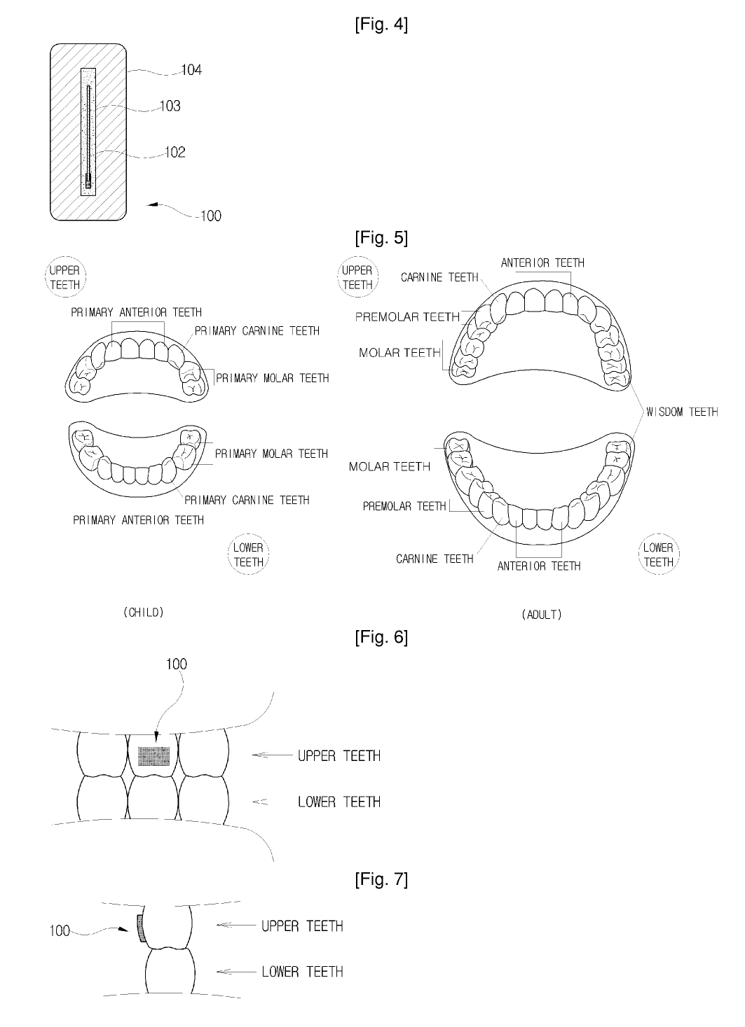

FIG. 3 is a perspective view showing the RFID tag of the present invention and FIG. 4 is the cross-sectional view of FIG. 3.

As seen in FIG. 3, the RFID tag 100 of the present invention comprises a chip 101 for storing the user's information, an antenna 102 for transmitting the user information stored in the chip 101, a housing 103 for fixing the chip 101 and the antenna 102 and a protective resin 104 for covering the housing 103.

The chip 101 has a square shape and stores the user information.

The chip 101 may be either an active chip or a passive chip.

The antenna 102 is connected with the chip 101 and transmits the user information stored in the chip 101.

The housing 103 fixes the chip 101 and the antenna 102.

The protective resin 104 covers the housing 103 which fixes the chip 101 and the antenna 102.

The protective resin 104 is a plastic material used on the visually prominent part of a damaged tooth by the dentists.

The protective resin 104 aids in attachment of the RFID tag 100 to the tooth and protects the RFID tag 100 from food or saliva.

FIG. 5 shows the arrangement of the teeth to which the RFID tag of the present invention is to be attached.

Referring to FIG. 5, the human teeth are divided into upper teeth and lower teeth. A child's teeth are divided into primary anterior teeth, primary canine teeth and primary molar teeth and an adult's teeth are divided into anterior teeth, canine teeth, premolar teeth, molar teeth and wisdom teeth.

The RFID tag 100 may be attached to an upper primary molar tooth for a child and to an upper premolar tooth or upper molar tooth for an adult.

A child's upper primary molar teeth erupt at the age of 2-3 years and shed at the age of 11-13 years. Since they are the longest lasting primary teeth and have a large area on the cheek side, they are adequate for attaching the RFID tag 100.

For adults, the upper premolar teeth or upper molar tooth are adequate for attaching the RFID tag 100.

FIG. 6 is the front view of the RFID tag of the present invention attached to an upper primary molar tooth of a child. FIG. 7 is the side view of FIG. 6.

As seen in FIG. 6 and FIG. 7, the RFID tag 100 is attached on the outside (cheek side) of an upper primary molar tooth in order not to be interfered by the tongue or food, while extending the recognition range of the chip 101.

In case the RFID tag 100 is attached on the inside of an upper primary molar tooth or on the outside of a lower primary molar tooth, the RFID tag may be easily detached from the tooth because of chewed food.

And, if the RFID tag 100 is attached on the inside of a lower primary molar tooth, the tongue may contact the RFID tag 100, resulting in discomfort.

The method of attaching the RFID tag 100 to an upper primary molar tooth is as follows.

First, the surface of an upper primary molar teeth is pre-treated, for example, by acid etching.

The pre-treatment is carried out in order to improve adhesion of the protective resin 104 of the RFID tag 100 to the tooth.

After the pre-treatment, an attach resin is coated on the surface of the protective resin 104 of the RFID tag 100.

The attach resin, one of materials used by dentists, acts as an adhesive attaching the protective resin 104 of the RFID tag 100 to the tooth.

After the coating of the attach resin, polymerization is carried out, so that the RFID tag 100 is attached on the surface of the pre-treated tooth.

For the polymerization of the protective resin 104 of the RFID tag 100 and the attach resin, either photopolymerization or autopolymerization may be employed.

Photopolymerization is carried out by placing the attach resin on the protective resin 104 of the RFID tag 100 and exposing it to a light source. Autopolymerization is carried out by mixing the protective resin 104 of the RFID tag 100 with the attach resin, so that the polymerization proceeds spontaneously.

A variety of embodiments may be derived from the above description.

Hereunder is given a description on an individual positioning system using the RFID tag and a method for using the same.

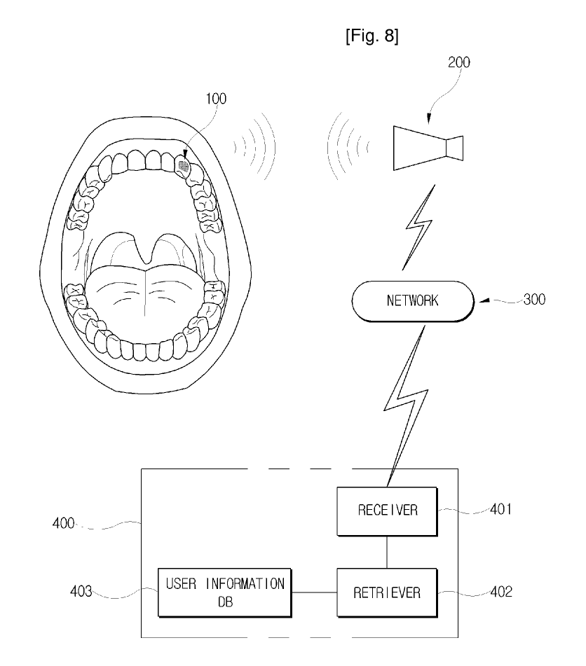

FIG. 8 is a schematic diagram of the RFID tag-based individual positioning system in accordance with the present invention.

Referring to FIG. 8, the individual positioning system comprises an RFID tag 100 which contains the user information and is attached to a tooth, a reader 200 which reads and detects the RFID tag 100, a network 300 which provides the user information decoded by the reader 200 to a server 400 and a server 400 which compares the user information of the RFID tag 100 received via the network 300 with the information stored in the server.

Description of the RFID tag 100 will be omitted because it was given above referring to FIG. 3 to FIG. 5.

The reader 200 reads and decodes the user information stored in the chip 101 of the RFID tag 100.

The reader 200 may be an inductively coupled type or an electromagnetic wave type depending on the particular communication type to be employed. The inductively coupled type uses coil antennae and is adequate for short-distance (about 1 m) or wired network. The electromagnetic wave type uses high-frequency antennae and is adequate for mid-to-long distance (over 1 m) or wireless network.

Either the inductively coupled type or the electromagnetic wave type may be employed in the present invention.

The reader 200 may be installed in public facilities or at busy streets. Alternatively, it may be a portable one.

The user information decoded by the reader 200 is transmitted to the server 400 via the network 300. The network may be a wired system, e.g., telephone network, Internet network, etc., or a wireless system, e.g., IR (infrared) communication network, Bluetooth network, wireless Internet network, etc.

The server 400 comprises a receiver 401 which stores the user information transmitted from the RFID tag 100 via the network 300, a user information DB (database) 403 in which the user information is stored and a retriever 402 which retrieves the user information form the user information DB 403 and compares it with the user information transmitted from the RFID tag 100.

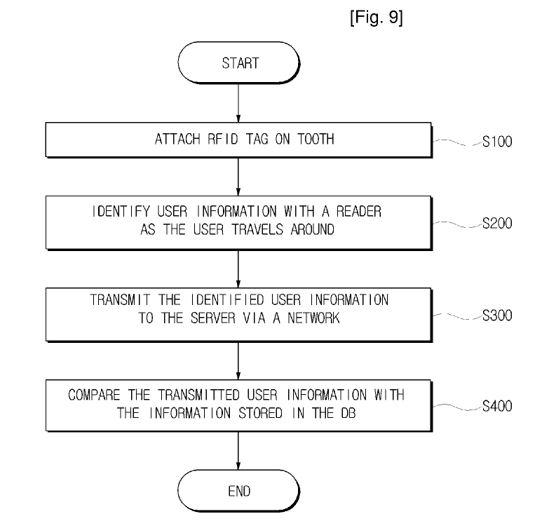

FIG. 9 is a flowchart for the individual positioning system of FIG. 8.

An RFID tag 100 comprising a chip 101 in which the user information is stored, an antenna 102 for transmitting signals, a housing 103 for fixing the chip and the antenna and a protective resin 104 is attached on a child's upper primary molar tooth or an adult's upper premolar tooth or upper molar tooth (S100).

The child or adult travels around within the reading range of the reader 200, with the tag 100 attached to the upper primary molar tooth, upper premolar tooth or upper molar tooth.

As the child or adult travels around within the reading range of the reader 200, the user information stored in the RFID tag 100 is read and decoded by the reader 200 (S200).

The user information decoded by the reader 200 is transmitted to the server 400 via the network 300 connected to the reader 200 (S300).

The transmitted user information is stored by the receiver 401 of the server 400.

The retriever 402 compares the user information stored by the receiver 401 with the user information stored in the user information DB 403 (S400).

That is, the retriever 402 retrieves the user information stored in the user information DB 403, compared it with the user information of the RFID tag 100 stored by the receiver 401 and determines if the two are identical.

The user information may further be provided to nearby police office or other public offices if the user information matches that of missing child or disappearance.

Further, for example, the reader may be built in personal portable devices, such as cell phones, so that the devices can be used only by their owner.

1. A tooth-attached RFID tag comprising:
a chip for storing user information;
an antenna for transmitting the user information stored in the chip;
a housing for fixing the chip and the antenna; and
a protective resin attached to a tooth for protecting the housing from at least one of food or saliva by covering the housing.

2. The tooth-attached RFID tag of claim 1, wherein the tooth is an upper molar tooth.

3. The tooth attached RFID tag of claim 2, wherein the tooth is an upper primary molar tooth for a child and an upper premolar tooth or an upper molar tooth for an adult.

4. A method for attaching an RFID tag comprising the steps of:
pre-treating a surface of a tooth by acid etching;
coating an attach resin on an RFID tag; and
polymerizing the attach resin, so that it is attached on the surface of the pre-treated tooth,
wherein the RFID tag comprises a chip for storing user information, an antenna for transmitting the user information stored in the chip, a housing for fixing the chip and the antenna and a protective resin attached to a tooth for protecting the housing from at least one of food or saliva by covering the housing.

5. The method of claim 4, wherein the tooth is an upper molar tooth.

6. The method of claim 5, wherein the tooth is an upper primary molar tooth for a child and an upper premolar tooth or an upper molar tooth for an adult.

7. The method of claim 6, wherein the polymerization is carried out by photopolymerization, in which the attach resin is coated on the protective resin of the RFID tag and is exposed to a light source.

8. The method of claim 6, wherein the polymerization is carried out by autopolymerization, in which the protective resin of the RFID tag and the attach resin are mixed, so that the polymerization proceeds spontaneously.

9. A system for using an RFID tag comprising:
an RFID tag which contains user information and is attached to a tooth;
a reader which reads and decodes the tooth-attached RFID tag;
a network which provides the user information decoded by the reader to a server; and
a server which receives the user information from the network and compares it with the user information stored in the server.

10. The system of claim 9, wherein the tooth is an upper molar tooth.

11. The system of claim 10, wherein the tooth is an upper primary molar tooth for a child and an upper premolar tooth or an upper molar tooth for an adult.

12. The system of claim 10, wherein the server comprises:
a receiver which stores the user information transmitted from the RFID tag via the network;
a user information database (DB) in which the user information is stored; and
a retriever which retrieves the user information from the user information DB and compares it with the user information transmitted from the RFID tag.

13. A method for using an RFID tag comprising the steps of:
pre-treating a surface of a tooth of a user by acid etching;
coating an attach resin on an RFID tag containing user information;
polymerizing the attach resin, so that it is attached on the surface of the pre-treated tooth;
reading the RFID tag through a reader as the user travels around;
transmitting the user information decoded by the reader to a server via a network; and
comparing the transmitted user information with stored user information in the server,
wherein the RFID tag comprises a chip for storing the user information, an antenna for transmitting the user information stored in the chip, a housing for fixing the chip and the antenna and a protective resin attached to a tooth for protecting the housing from food or saliva by covering the housing.

14. The method of claim 13, wherein the tooth is an upper molar tooth.

15. The method of claim 14, wherein the tooth is an upper primary molar tooth for a child and an upper premolar tooth or an upper molar tooth for an adult.
